(19) United States
(12) Patent Application Publication
(10) Pub. No.: US 2012/0088675 A1
(43) Pub. Date: Apr. 12, 2012

(54) SYSTEMS AND DEVICES FOR ELECTRICAL FILTERS

(76) Inventors: David Pires, North Vancouver (CA); Sergey V. Uchaykin, Burnaby (CA); Jacob Craig Petroff, Burnaby (CA); Alexandr M. Tcaciuc, New Westminster (CA)

(21) Appl. No.: 13/253,741

(22) Filed: Oct. 5, 2011

Related U.S. Application Data
(60) Provisional application No. 61/391,465, filed on Oct. 8, 2010.

(51) Int. Cl. H01P 1/207; H01P 1/202

(52) U.S. Cl. 505/210; 333/206

(57) ABSTRACT

Adaptations and improvements to tubular metal powder filters include employing a polyester binder or a binder formed of vacuum grease, employing metal powders of multiple different chemical compositions and/or spanning multiple different ranges of grain-size, replacing the outer conductive housing and metal powder components with a single structure formed of sintered metal powder, and texturing (such as rifling, threading, sanding, or scratching) an inner surface of the outer conductive housing. The various adaptations and improvements are designed to accommodate single-ended and differential signaling, as well as superconducting and non-superconducting applications.

### CROSS REFERENCE TO RELATED APPLICATION

This application claims benefit under 35 U.S.C. 119(e) of US Provisional Patent Application Ser. No. 61/391,465, filed Oct. 8, 2010, and entitled “Systems and Devices For Electrical Filters,” which is incorporated herein by reference in its entirety.

### BACKGROUND

### Field

The present systems and devices generally relate to electrical filters and particularly relate to superconducting high frequency dissipation filters employing tubular geometries.

### Refrigeration

According to the present state of the art, a superconducting material may generally only act as a superconductor if it is cooled below a critical temperature that is characteristic of the specific material in question. For this reason, those of skill in the art will appreciate that an electrical system that implements superconducting components may implicitly include a refrigeration system for cooling the superconducting materials in the system. Systems and methods for such refrigeration systems are well known in the art. A dilution refrigerator is an example of a refrigeration system that is commonly implemented for cooling a superconducting material to a temperature at which it may act as a superconductor. In common practice, the cooling process in a dilution refrigerator may use a mixture of at least two isotopes of helium (such as helium-3 and helium-4). Full details on the operation of typical dilution refrigerators may be found in F. Pobell, Matter and Methods at Low Temperatures, Springer-Verlag Second Edition, 1996, pp. 120-156. However, those of skill in the art will appreciate that the present systems and devices are not limited to applications involving dilution refrigerators, but rather may be applied using any type of refrigeration system.

### Electrical Signal Filtering

During transmission, an electrical signal typically comprises a plurality of components each transmitting at a different frequency. The “filtering” of an electrical signal typically involves the selective removal of certain frequencies from the electrical signal during transmission. Such filtering may be accomplished “passively” or “actively.” A passive electrical filter is one that operates without additional power input; that is, the filtering is accomplished by the natural characteristics of the materials or devices through which the electrical signal is transmitted. Many such passive filters are known in the art, including filters that implement lumped elements such as inductors and capacitors, collectively referred to as lumped element filters (LEFs).

Simple, passive lumped element filters include low-pass and high-pass filters. A low-pass filter is one that substantially filters out higher frequencies and substantially allows lower frequencies to pass through. Conversely, a high-pass filter is one that substantially filters out lower frequencies and substantially allows higher frequencies to pass through. The concepts of low-pass and high-pass filters may be combined to produce “band-pass” filters, which effectively transmit a given range of frequencies and filter out frequencies that fall outside (above or below) of that range. Similarly, “band-stop” filters may be implemented which effectively transmit most frequencies and filter out frequencies that fall inside a given range.

### Metal Powder Filters

First introduced in 1985 in a Ph.D. thesis entitled “Macroscopic Quantum Tunneling and Energy-Level Quantization in the Zero Voltage State of the Current-Biased Josephson Junction” by John Martinis of the University of California, Berkeley, the metal powder filter is a form of high frequency dissipation filter. In its most general form, the metal powder filter employs a hollow conductive housing having an inner volume that is filled with a mixture comprising a plurality of metal particles (e.g., a metal powder) and an epoxy binder. A portion of a conducting wire extends through the inner volume of the housing such that the portion of the conducting wire is at least partially immersed or partially surrounded in the plurality of metal particles. The particles of the metal powder are conductive and together provide a very large surface area over which high frequency signals carried on the conducting wire are dissipated via skin-effect damping. In the Ph.D. thesis, Martinis employs a cylindrical tubular geometry for the outer conductive housing and two different variants for the inner conducting wire. In the first variant, the inner conducting wire is coiled around the longitudinal axis within the tubular housing in order to maximize the contact surface area between the conducting wire and the metal powder epoxy mixture. In the second variant, the inner conducting wire is straight to realize a coaxial geometry in the filter. Throughout this specification, a metal powder filter employing a cylindrical tubular outer conductor and an inner conducting wire (either coiled or straight/coaxial) is generally referred to as the “Martinis Design.” Much of this thesis work, including both variants of the Martinis Design, was subsequently re-published two years later in Martinis et al., Physical Review B, 35, 10, Apr. 1987. The Martinis Design has also been characterized and implemented by others, such as in Fukushima et al., IEEE Transactions on Instrumentation and Measurement, 46, 2, Apr. 1997 and Bladh et al., Review of Scientific Instruments, 74, 3, Mar. 2003. Furthermore, metal powder filters of the coaxial-type are described in U.S. Pat. No. 7,456,702 and U.S. Pat. No. 7,791,430 and a variant employing a planar buried strip line geometry is described in US Patent Publication US 2008-0284545.

Metal powder filters have particular utility in superconducting applications, such as in the input/output system providing electrical communication to/from a superconducting computer processor. For example, a multi-metal powder filter assembly is employed for this purpose in U.S. patent application Ser. No. 12/016,801. The multi-filter assembly includes a single conductive volume through which multiple through-holes are bored to provide a set of longitudinal passages. Each filter is realized by a respective coiled conducting wire extending through each passage, where the volume of each passage is filled with a mixture of metal powder and epoxy. The multi-filter assembly therefore provides multiple Martinis Design filters in one structure. In another example, the inner conducting wire of the Martinis Design is replaced by a printed circuit board (PCB) carrying conductive traces and lumped elements such as capacitors, inductors, and/or resistors. Versions of this design that employ single-ended signaling are described in U.S. Pat. No. 8,008,991, while versions of this design that are adapted to employ differential signaling are described in US Patent Publication 2010-0157552.

The Martinis Design and other aforementioned incarnations of metal powder filters share at least one common property: they all implement epoxy as a binder material for suspending the metal powder grains within the outer conductive housing. In general, the range of physical properties that can be provided by a single material, such as epoxy, is limited. An exemplary physical property that is of particular relevance to the binder material in a metal powder filter (i.e., a high frequency dissipation filter) is the dielectric loss tangent. In general, the higher the dielectric loss tangent of a material, the more effectively it will dissipate high frequency signals when employed as the binder material in a metal powder filter. Epoxy can only provide a limited range of dielectric loss tangent, thus, there remains a need in the art for alternative metal powder filter designs for applications where epoxy is insufficient as the binder material or is otherwise undesired for use as the binder material.

### Single-Ended Signaling vs. Differential Signaling

Single-ended signaling is a term used to describe a simple wiring approach whereby a varying voltage that represents a signal is transmitted using a single wire. This single-ended signal is typically referenced to an absolute reference voltage provided by a positive or negative ground or another signal somewhere in the system. For a system that necessitates the transmission of multiple signals (each on a separate signal path), the main advantage of single-ended signaling is that the number of wires required to transmit multiple signals is simply equal to the number of signals plus one for a common ground. However, single-ended signaling can be highly susceptible to noise that is picked up (during transmission) by the signal wire and/or the ground path, as well as noise that results from fluctuations in the ground voltage level throughout the system. In single-ended signaling, the signal that is ultimately received and utilized by a receiving circuit is equal to the difference between the signal voltage and the ground or reference voltage at the receiving circuit. Thus, any fluctuations in the signal and/or reference voltage that occur between sending and receiving the signal can result in a discrepancy between the signal that enters the signal wire and the signal that is received by the receiving circuit.

Differential signaling is a term used to describe a wiring approach whereby a data signal is transmitted using two complementary electrical signals propagated through two separate wires. A first wire carries a varying voltage (and/or current) that represents the data signal and a second wire carries a complementary signal that may be equal and opposite to the data signal. The complementary signal in the second wire is typically used as the particular reference voltage for each differential signal, as opposed to an absolute reference voltage throughout the system. In single-ended signaling, a single ground is typically used as a common signal return path. In differential signaling, a single ground may also be provided as a common return path for both the first wire and the second wire, although because the two signals are substantially equal and opposite they may cancel each other out in the return path.

Differential signaling has the advantage that it is less susceptible to noise that is picked up during signal transmission and it does not rely on a constant absolute reference voltage. In differential signaling, the signal that is ultimately received and utilized by a receiving circuit is equal to the difference between the data signal voltage (and/or current) carried by the first wire and the complementary signal voltage (and/or current) carried by the second wire. There is no absolute ground reference voltage. Thus, if the first wire and the second wire are maintained in close proximity throughout the signal transmission, any noise coupled to the data signal is likely also to couple to the reference signal and therefore any such noise may be cancelled out in the receiving circuit. Furthermore, because the data signal and the complementary signal are, typically, roughly equal in magnitude but opposite in sign, the signal that is ultimately received and utilized by the receiving circuit may be approximately twice the magnitude of the data signal alone. These effects can help to allow differential signaling to realize a higher signal-to-noise ratio than single-ended signaling. The main disadvantage of differential signaling is that it uses approximately twice as many wires as single-ended signaling. However, in some applications this disadvantage is more than compensated by the improved signal-to-noise ratio of differential signaling.

### BRIEF SUMMARY

An electrical filter may be summarized as including a hollow outer conductive housing; an inner conductor at least partially disposed in the hollow outer conductive housing; a polyester binder disposed in the hollow outer conductive housing; and a plurality of metal particles suspended in the polyester binder between the inner conductor and the hollow outer conductive housing such that the inner conductor is at least partially surrounded in the plurality of metal particles. The inner conductor may be formed of a material that is superconducting below a critical temperature. The metal particles may include a metal powder.

An electrical filter may be summarized as including a hollow outer conductive housing; an inner conductor at least partially disposed in the hollow outer conductive housing; a binder substance comprising vacuum grease disposed in the hollow outer conductive housing; and a plurality of metal particles suspended in the binder substance between the inner conductor and the hollow outer conductive housing such that the inner conductor is at least partially surrounded in the plurality of metal particles. The inner conductor may be formed of a material that is superconducting below a critical temperature. The metal particles may include a metal powder.

An electrical filter may be summarized as including an outer conductive housing structure formed of sintered metal powder; a through-hole extending through the outer conductive housing structure; and an inner conductor positioned in the through-hole. The inner conductor may be formed of a material that is superconducting below a critical temperature.

An electrical filter may be summarized as including an outer conductive housing having an inner surface; an inner conductor disposed in the outer conductive housing; and a plurality of metal particles suspended in a binder material disposed between the inner conductor and the outer conductive housing, wherein the inner surface of the outer conductive housing is textured to increase a surface area thereof. The inner surface of the outer conductive housing may be at least one of threaded, rifled, sanded, and scratched. The inner conductor may be formed of a material that is superconducting below a critical temperature. The plurality of metal particles may include a metal powder.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a sectional view of a metal powder filter embodying the coaxial variant of the Martinis Design.

FIG. 2 is a sectional view of an embodiment of an electrical filter formed of a sintered metal structure according to the present systems and devices.

FIG. 3 is a partial cut-away perspective view of an embodiment of a metal powder filter having an outer conductive housing with a threaded inner surface in accordance with the present systems and devices.

### DETAILED DESCRIPTION

In the following description, some specific details are included to provide a thorough understanding of various disclosed embodiments. One skilled in the relevant art, however, will recognize that embodiments may be practiced without one or more of these specific details, or with other methods, components, materials, etc. In other instances, well-known structures associated with electrical filters have not been shown or described in detail to avoid unnecessarily obscuring descriptions of the embodiments of the present systems and devices.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment,” or “an embodiment,” or “another embodiment” means that a particular referent feature, structure, or characteristic described in connection with the embodiment is included in at least one embodiment. Thus, the appearances of the phrases “in one embodiment,” or “in an embodiment,” or “another embodiment” in various places throughout this specification are not necessarily all referring to the same embodiment. Furthermore, the particular features, structures, or characteristics may be combined in any suitable manner in one or more embodiments.

It should be noted that, as used in this specification and the appended claims, the singular forms “a,” “an,” and “the” include plural referents unless the content clearly dictates otherwise. Thus, for example, reference to an electrical system including “an electrical filter” includes a single electrical filter, or two or more electrical filters. It should also be noted that the term “or” is generally employed in its sense including “and/or” unless the content clearly dictates otherwise.

The headings provided herein are for convenience only and do not interpret the scope or meaning of the embodiments.

The various embodiments described herein provide systems and devices for metal powder filters that are adapted from the Martinis Design to accommodate system requirements and/or achieve some specific function.

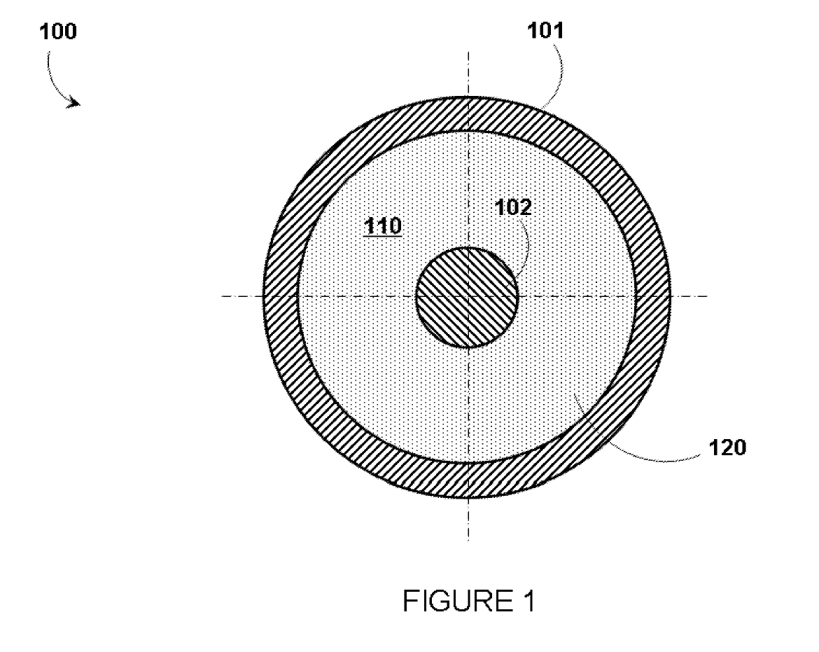

FIG. 1 is a sectional view of a metal powder filter 100 embodying the coaxial variant of the Martinis Design. Metal powder filter 100 employs a tubular geometry and includes a cylindrical outer conductive housing 101 and an inner conducting wire 102 that is arranged coaxially therein. A cylindrical volume 110 is defined between the inner surface of the outer conductive housing 101 and the outer surface of the inner conducting wire 102. In the Martinis Design and all subsequent designs seen in the prior art, volume 110 is filled with a mixture 120 of metal powder and epoxy. The epoxy is used as a binder to suspend the metal powder in place about the inner conductor 102 and may also improve structural support and thermalization of the filter 100. Epoxy binders are generally quite versatile in that they can be designed to provide a wide range of physical properties (e.g., hardness, coefficient of thermal expansion, cure-time, thermal conductivity, etc.). Nevertheless, epoxy binders do have a limited range of physical properties (e.g., dielectric loss tangent) and, in some applications, in may be preferable to employ a binder that is made of something other than epoxy. In accordance with the present systems and devices, the metal powder may be suspended in an alternative binder substance that is not epoxy. For example, in some embodiments of the present systems and devices, volume 110 may be filled with a mixture of metal powder and polyester, such as a polyester resin or a polyester binder.

Thus, an embodiment of the present systems and devices includes an electrical filter 100 (e.g., a low-pass filter) having an outer conductive housing 101, an inner conductor 102 disposed in the outer conductive housing 101, a plurality of metal particles disposed between the inner conductor and the outer conductive housing, and a polyester binder. An example of a suitable polyester compound to act as a binder in this embodiment is Oatey® X-15 Bonding Adhesive. The metal particles and polyester binder together are represented by 120 in FIG. 1. In some embodiments, the metal particles may include metal powder particles (e.g., grains) formed of, for example, copper, brass, bronze, or stainless steel. In some embodiments, the inner conductor 102 may be arranged substantially coaxially and collinear with the outer conductive housing 101. In other embodiments the inner conductor may employ an alternative geometry, such as a coiled or wound geometry. In other embodiments, the inner conductor may include lumped element devices and/or a printed circuit board.

In the above description, polyester is used as an exemplary binder substance for applications in which use of an epoxy binder is undesirable. Compounds of polyester may be employed to provide physical properties that differ from and, in some cases, may be unachievable by, an epoxy binder. For example, compounds of polyester may be designed to provide a higher dielectric loss tangent compared to compounds of epoxy. However, in accordance with the present systems and devices, still other substances may be used for the binder material. For example, an alternative to both epoxy and polyester is a vacuum grease, such as Apiezon® N Grease from Canemco & Marivac. Vacuum grease may not solidify like epoxy and polyester, but may still serve as a suitable binder in some applications. Similarly, a varnish such as GE Low Temperature Varnish from Oxford Instruments may be used as a binder substance. Furthermore, in some embodiments it may be most practical to simply fill volume 110 with dry metal powder particles alone without the use of any binder substance.

The various embodiments of electrical filters described herein include a volume 110 defined in between an outer conductive housing 101 and an inner conductor 102, where the volume 110 is at least partially filled with a metal powder, or a mixture of a metal powder and a binder substance. In accordance with the present systems and devices, the composition and/or characteristics of the metal powder may be selected to achieve some design criterion. For example, in the known art a metal powder filter typically employs metal powder particles that are substantially uniform and homogenous in chemical composition. In accordance with some embodiments of the present systems and devices, improved filtering performance may be achieved by at least partially filling volume 110 with a metal powder mixture that includes grains of at least two different chemical compositions. For example, volume 110 may be at least partially filled with a mixture comprising both copper powder and brass powder. Those of skill in the art will appreciate, in light of the teachings herein, that any combination of different metal powders (e.g., copper powder, brass powder, stainless steel powder, bronze powder, etc.) may be employed for this purpose. Similarly, the composition and/or characteristics of the binder material may be selected to provide some defined criterion, and this may be achieved by implementing a binder material other than epoxy, such as polyester, vacuum grease, etc.

Metal powders are typically available in specific ranges of grain size depending on an upper- and a lower-bound mesh size used to sieve the powder. In the known art, metal powder filters typically employ powder grains falling within a specific and fairly narrow range of grain size. However, in accordance with the present systems and methods, employing powder grains spanning a wider range of grain sizes and/or multiple different ranges of grain sizes can help to reduce resonances in the electrical filter and thereby improve performance. Thus, volume 110 may be at least partially filled with a mixture comprising metal powders spanning a larger range and/or multiple ranges of grain sizes. For example, volume 110 may be at least partially filled with a mixture comprising a first copper powder having a grain size in the range of 5-40 microns, a second copper powder having a grain size in the range of 210-297 microns, and a third copper powder having a grain size in the range of 590-840 microns. As another example, volume 110 may be at least partially filled with a mixture comprising a copper powder having a grain size in the range of 44-105 microns, a brass powder having a grain size in the range of 74-250 microns, and a steel powder having a grain size in the range of 840-1190 microns. Those of skill in the art will appreciate that any number of powders having any range of grain sizes, any number of ranges of grain sizes, and/or any chemical composition may similarly be employed.

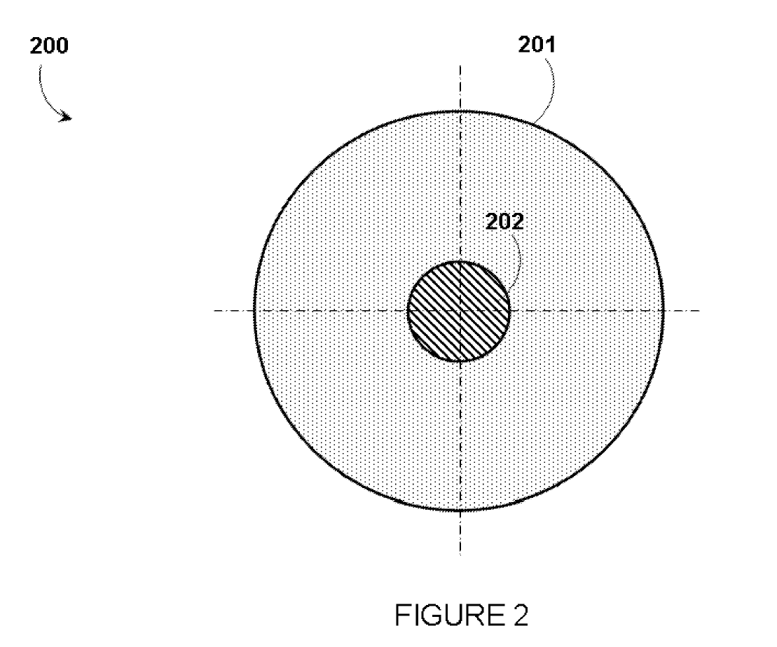

In another aspect of the present systems and devices, the combination of the outer conductive housing 101 and the filler material 120 (e.g., the mixture of metal powder and a binder, such as epoxy, polyester, vacuum grease, etc.) may be replaced by a single structure formed of sintered metal. FIG. 2 is a sectional view of an embodiment of an electrical filter 200 formed of a sintered metal structure 201. Filter 200 includes an outer conductive housing structure 201 formed of sintered metal powder, for example, sintered brass powder, copper powder, steel powder, or bronze powder. Structure 201 includes a through-hole through which an inner conductor 202 is passed. Thus, filter 200 realizes a similar structure and function to that of filter 100 from FIG. 1 in that filter 200 includes an inner conductor 202 that is completely surrounded by a metal powder. However, filter 200 is distinct from filter 100 in that the metal powder of filter 200 is sintered to form a substantially solid and rigid structure such that no binder substance and no outer conductive housing are needed.

In some embodiments, it is advantageous to ensure a tight fit (e.g., a tight interference fit) between the sintered outer conductive housing structure 201 and the inner conductor 202 in filter 200. This can be achieved, for example, by heating structure 201 such that it slightly expands and cooling inner conductor 202 such that it slightly contracts before mating the two components. Thus, filter 200 may be constructed by feeding a cooled inner conductor 202 into the through-hole in a heated sintered outer conductive housing structure 201 and then allowing the two components to thermally equilibrate such that structure 201 slightly contracts and inner conductor 202 slightly expands.

While filter 200 is shown in FIG. 2 as having a circular cross section, those of skill in the art will appreciate that alternative geometries having any cross section (such as rectangular, square, octagonal, etc.) may similarly be employed. In some embodiments, inner conductor 202 may be formed of a material that is superconducting below a critical temperature. In some embodiments, inner conductor 202 may have a non-circular cross section, or may be embodied on a printed circuit board including lumped element devices such as inductors, capacitors, and/or resistors.

In another aspect of the present systems and devices, the performance of a metal powder filter may be improved by adding texture to an inner surface of the outer conductive housing. For example, an inner surface of the outer conductive housing may be threaded, rifled, sanded, scratched, or otherwise roughened. Adding texture to the inner surface of the outer conductive housing may improve the performance of the filter by increasing the surface area of the inner surface of the outer conductive housing and/or by increasing the resistivity of the inner surface of the outer conductive housing. A threaded, rifled, sanded, scratched, or otherwise roughened texture may increase the resistivity of the inner surface of the outer conductive housing by disrupting current flow across the surface and/or through the metal powder grains proximate the surface.

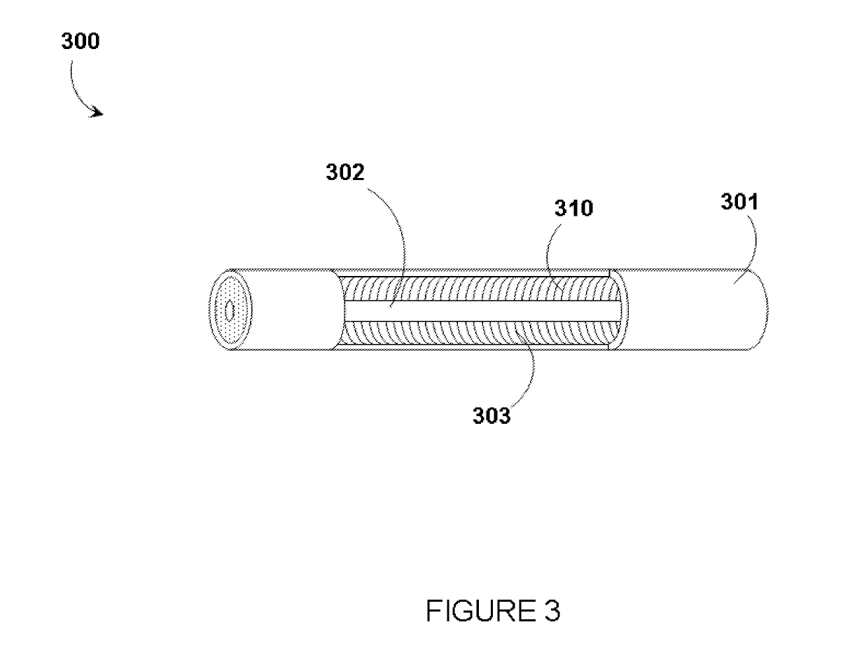

FIG. 3 is a partial cut-away perspective view of an embodiment of a metal powder filter 300 having an outer conductive housing 301 with a threaded inner surface 303 in accordance with the present systems and devices. Filter 300 includes an inner conductor 302 which, in some embodiments, may be formed of a material that is superconducting below a critical temperature. In some embodiments, inner conductor 302 may be formed of a single piece of straight or coiled wire. In other embodiments, inner conductor 302 may be carried on a printed circuit board including lumped elements such as inductors, capacitors, and/or resistors. An inner volume 310 is defined in between outer conductive housing 301 and inner conductor 302. Though not shown in the Figure, inner volume 310 may be at least partially filled with metal particles such as a metal powder, and the metal powder may be suspended in a binder material such as epoxy, polyester, or vacuum grease.

Certain aspects of the present systems and devices may be realized at room temperature, and certain aspects may be realized at a superconducting temperature. Thus, throughout this specification and the appended claims, the terms “superconducting” and “superconductor” are used to indicate a material that is capable of behaving as a superconductor at an appropriate temperature. A superconducting material may not necessarily be acting as a superconductor at all times in all embodiments of the present systems and devices. It is also noted that the teachings provided herein may be applied in non-superconducting applications, such as in radio frequency transformers formed out of gold.

Those of skill in the art will appreciate that any or all of the various embodiments described herein may be combined with any or all of the embodiments of alternative metal powder filter geometries described in US Patent Publication 2011-0183853.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, methods and apparatus, not necessarily the exemplary systems, methods and apparatus generally described above.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to US Provisional Patent Application Ser. No. 61/391,465, filed Oct. 8, 2010, and entitled “Systems And Devices For Electrical Filters,” U.S. Pat. No. 7,456,702, U.S. Pat. No. 7,791,430, US Patent Publication US 2008-0284545, U.S. patent application Ser. No. 12/016,801, U.S. Pat. No. 8,008,991, US Patent Publication 2010-0157552, US Patent Publication 2009-0102580, and US Patent Publication 2011-0183853, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electrical filter comprising:
a hollow outer conductive housing;
an inner conductor at least partially disposed in the hollow outer conductive housing;
a polyester binder disposed in the hollow outer conductive housing; and
a plurality of metal particles suspended in the polyester binder between the inner conductor and the hollow outer conductive housing such that the inner conductor is at least partially surrounded in the plurality of metal particles.

2. The electrical filter of claim 1 wherein the inner conductor is formed of a material that is superconducting below a critical temperature.

3. The electrical filter of claim 1 wherein the plurality of metal particles includes a metal powder.

4. An electrical filter comprising:
an outer conductive housing structure formed of sintered metal powder;
a through-hole extending through the outer conductive housing structure; and
an inner conductor positioned in the through-hole.

5. The electrical filter of claim 4 wherein the inner conductor is formed of a material that is superconducting below a critical temperature.

6. An electrical filter comprising:
an outer conductive housing having an inner surface;
an inner conductor disposed in the outer conductive housing; and
a plurality of metal particles suspended in a binder material disposed between the inner conductor and the outer conductive housing, wherein the inner surface of the outer conductive housing is textured to increase a surface area thereof.

7. The electrical filter of claim 6 wherein the inner surface of the outer conductive housing is at least one of threaded, rifled, sanded, and scratched.

8. The electrical filter of claim 6 wherein the inner conductor is formed of a material that is superconducting below a critical temperature.

9. The electrical filter of claim 6 wherein the plurality of metal particles includes a metal powder.
